(19) United States
(12) Patent Application Publication
(10) Pub. No.: US 2022/0134265 A1
(43) Pub. Date: May 5, 2022

(54) SERVER FAUCET OUTLET FILTER ADAPTER

(71) Applicant: BUNN-O-MATIC CORPORATION, Springfield, IL (US)

(72) Inventors: Charles H. CLARK, Springfield, IL (US); Brian YEAZEL, Springfield, IL (US); Matthew KNOUS, Springfield, IL (US)

(21) Appl. No.: 17/511,996

(22) Filed: Oct. 27, 2021

Related U.S. Application Data
(60) Provisional application No. 63/107,740, filed on Oct. 30, 2020.

(51) Int. Cl. B01D 35/04; B01D 29/05; B01D 35/30; B01D 39/10

(52) U.S. Cl. CPC B01D 35/04; B01D 29/05; B01D 35/306; B67D 2210/0001; B01D 2239/0442; B01D 2201/305; B01D 2201/306; B01D 39/10

(57) ABSTRACT

A filter adapter removably attachable to a faucet assembly of a beverage server is disclosed. The filter adapter filters elements flowing from the beverage server and includes a body having an opening, an outlet passage, and a filter material. The filter material is seated inside the body through the opening and along the outlet passage. The filter material captures undesirable elements, thereby preventing these elements from dispensing into a beverage container.

### CROSS-REFERENCE TO RELATED APPLICATIONS

This application claims priority to U.S. Provisional Patent Application Ser. No. 63/107,740, filed Oct. 30, 2020. The disclosures set forth in the referenced application is incorporated herein by reference in its entirety.

### BACKGROUND

The present disclosure generally relates to a beverage server, and more specifically, to a filtering adapter attachable to a faucet assembly of the beverage serving apparatus.

Generally, a beverage server includes a faucet assembly operable to dispense a beverage, such as coffee, from a reservoir of the beverage server into a container. In some instances, undesirable elements, such as coffee grounds, may flow into the container from the reservoir, which can affect an overall experience of an individual consuming the beverage.

Brewing grounds being dispensed in a container can occur for a variety of reasons. For example, an operator of the beverage server, when initiating a brewing process, may inadvertently pour coffee grounds between a filter paper and a brewing basket housing the filter paper, which places the coffee grounds in a flow path into the beverage server reservoir. As another example, a portion of filter paper may fold over during brewing of the coffee, which can result in grounds flowing over the edge of the filter paper and into the beverage server reservoir. In any case, many causes exist for brewing grounds being dispensed into a beverage container.

### BRIEF DESCRIPTION OF THE DRAWINGS

FIG. 1 is an exploded view of a beverage server faucet assembly and a filter adapter attachable to the faucet assembly;

FIG. 2 is a perspective view of a filter adapter engaged with a beverage server faucet assembly;

FIGS. 3 and 4 are front and rear views of a filter adapter attachable to a faucet assembly of a beverage server;

FIG. 5 is a lateral cross-sectional view of a filter adapter attachable to a faucet assembly of a beverage server;

FIGS. 6 and 7 are overhead and bottom views of a filter adapter attachable to a faucet assembly of a beverage server;

FIGS. 8-10 are various views of a filter material situated in a filter adapter attachable to a faucet assembly of a beverage server;

FIG. 11 is an exploded view of a second embodiment of a filter adapter attachable to a faucet assembly of a beverage server;

FIG. 12 is a perspective view of a second embodiment of a filter adapter engaged with a beverage server faucet assembly;

FIGS. 13 and 14 are front and rear views of a second embodiment of a filter adapter attachable to a faucet assembly of a beverage server;

FIGS. 15 and 16 are overhead and bottom views of a second embodiment of a filter adapter attachable to a faucet assembly of a beverage server;

FIG. 17 is an exploded view of a third embodiment of a filter adapter attachable to a faucet assembly of a beverage server;

FIG. 18 is a perspective view of a third embodiment of a filter adapter engaged with a beverage server faucet assembly; and

FIGS. 19-21 are various views of a second embodiment of a filter adapter attachable to a faucet assembly of a beverage server.

### DETAILED DESCRIPTION

While the present disclosure may be susceptible to embodiment in different forms, there is shown in the drawings, and described herein in detail, embodiments with the understanding that the present description exemplifies principles of the disclosure and does not intend to exhaust or limit the disclosure to the details of construction and the arrangements of components set forth in the following description and illustrated in the drawings. The present disclosure is described in connection with one or more contemplated embodiments which are not intended to be limiting of the scope of the present disclosure. The present disclosure is intended to encompass those embodiments as well as equivalents and variations.

Terms including beverage, brewed, brewing, and brewed beverage, as may be used herein, are intended to be broadly defined as including, but not limited to the brewing or making of tea, coffee, and any other beverages or food substances that will benefit from the present disclosure. This broad interpretation is also intended to include, but be limited to, any process of dispensing, infusing, steeping, reconstituting, diluting, dissolving, saturating, or passing a liquid through or otherwise mixing or combining a beverage substance with a liquid such as water without limitation to the temperature of such liquid unless specified. This broad interpretation is also intended to include, but is not limited to beverage substances such as ground coffee, tea, liquid beverage concentrate, powdered beverage concentrate, flaked, granular, freeze-dried or other forms of materials including liquid, gel, crystal, or other form of beverage or food materials to obtain a desired beverage or food product. This broad interpretation is further intended to include, without limitation, at least funnel and filter-type, packet or pouch-type, pod-type, or other pre-packaged or unpackaged forms of retaining and brewing a beverage or making of a food product. The terms heated water may be interpreted as hot water, and generally refers to adding energy to water to heat the water above ambient temperature.

Embodiments presented herein disclose a filter adapter removably attachable to a faucet assembly of a beverage server. The filter adapter includes a filter material, such as a mesh or a sieve, to intercept the flow of undesirable elements (e.g., brewing grounds) into a beverage container. More particularly, the filter adapter attaches to the outlet of the faucet assembly such that a beverage flowing into the beverage container naturally flows out of the faucet assembly and through the filter material, without influencing the flow of the beverage into the container. The filter material captures the undesirable elements, thereby preventing these elements from dispensing into the beverage container.

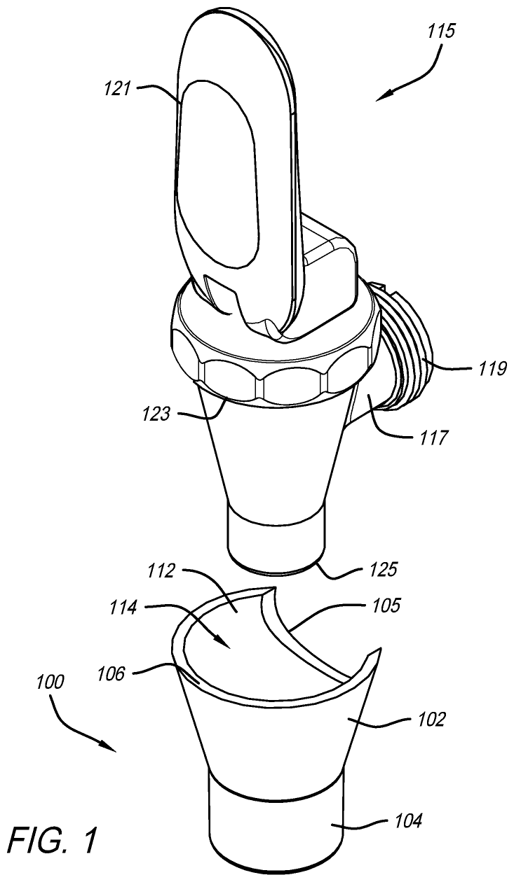

Referring now to FIG. 1, a filter adapter 100 removably attachable to a server faucet assembly 115 (also referred to herein as a “server faucet 115”) of a beverage brewer is shown. The beverage brewer (not shown) is used to make a heated beverage, such as coffee, tea, or soup. For instance, the beverage brewer may be used to brew and serve coffee. Such a brewer is of known construction and typically includes a hot water reservoir (not shown) which controllably dispenses hot water through a water supply dispensing tube connected to a spray head and distributed onto a beverage making substance retained in a substance holder or funnel. When used to make a heated beverage, a heater of a liquid reservoir of the brewer may controllably heat the liquid (water) to a desired temperature. For making coffee and tea, the water in the liquid reservoir may be heated at a temperature approaching boiling, e.g., about 190-205 degrees Fahrenheit. Such a heating element may be coupled with and controlled by a controller.

Further, an inlet tube may be coupled to and communicate with the liquid reservoir for dispensing liquid into the liquid reservoir. The controller is operable to permit liquid to flow out of the reservoir via an outlet tube. A controllable outlet valve is associated with the outlet tube and controllably operated by the controller. When the outlet valve is open, liquid flows out of the outlet tube through a tube opening to a spray head located within a sump area to be distributed over beverage making material positioned in a brew funnel to allow the liquid to contact the beverage making material to make a desired beverage.

The brewed beverage is then passed into a container such as a coffee carafe for distribution and consumption via the server faucet 115, which may be coupled with the server reservoir via a threaded attachment 119, connecting a tubular fitting of the beverage server to a valve chamber 117. An operator may pull a handle 121 of the server faucet 115, which causes the beverage to flow through the valve chamber 117 into a generally conically shaped body 123 and out an outlet passage 125. Liquid leaving the outlet passage 125 may flow into the container for distribution and/or consumption.

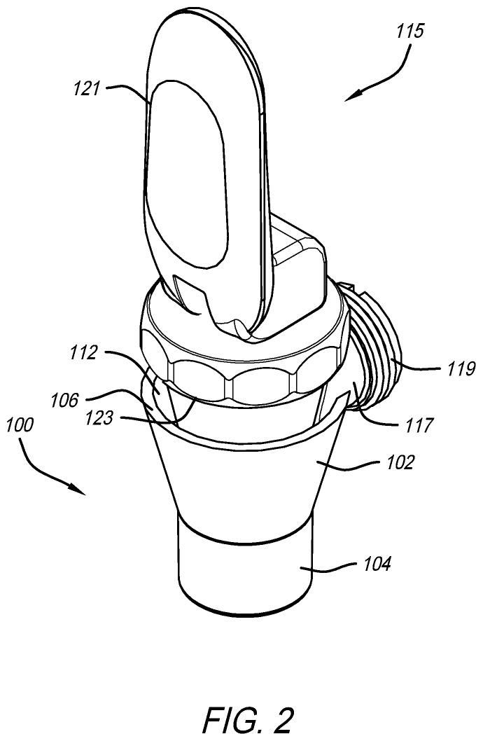

For various reasons stated herein, undesirable elements such as coffee grounds and solid deposits may inadvertently flow from the server reservoir into the container, potentially affecting the flavor of the beverage and overall experience for the consumer. To address this, the filter adapter 100 may be removably attached to the server faucet 115, in the manner shown in FIG. 2. As further described herein, the filter adapter 100 includes a filter material, such as a mesh or a sieve, used to capture such undesirable elements immediately prior to the beverage liquid pouring into the container from the server faucet assembly 115.

In an embodiment, the filter adapter 100 may be formed of an elastomeric material, such as silicon rubber. Of course other materials, such as other rubber materials, plastics, and stainless steel can be used to form the filter adapter 100, either individually or in combination with the elastomeric material. In addition, the filter adapter 100 may incorporate antimicrobial additives to prevent food safety issues such as contamination. Illustratively, the filter adapter 100 has a generally conically shaped body 102 having a generally semi-circular-shaped seating 105, a generally cylindrically shaped neck 104, a lip 106, and an inner body 112. In an embodiment, the aforementioned components of the filter adapter 100 may be formed as a single mold. The filtering material, further described herein, may be inserted through an opening 114 at the upper portion of the body 102 and within the neck 104.

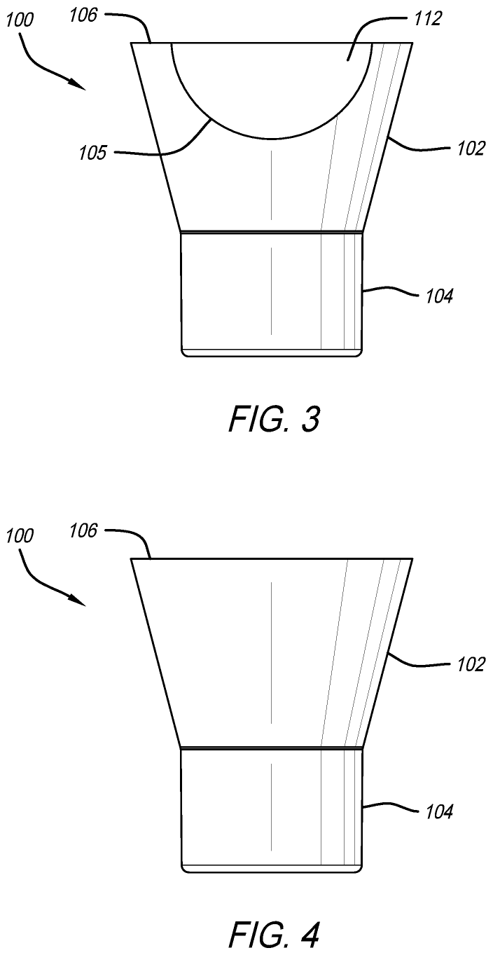

As shown in FIG. 2, the elastomeric material of the filter adapter 100 enables the filter adapter 100 to slide onto and tightly contact the faucet body 123 and provide a seal around the nose portion thereof. The seating 105 generally conforms with the cylindrical shape of the valve chamber 117 to allow the valve chamber 117 to be situated atop the seating 105. By allowing the filter adapter 100 to be releasably attached to the server faucet assembly 115, an operator may remove the filter adapter 100 with relative ease and without the need for external tools, e.g., for the purposes of cleaning captured grounds and other deposits from the filter adapter 100. FIGS. 3 and 4 depict additional views of the filter adapter 100. Specifically, FIG. 3 presents a rear-facing view of the filter adapter 100, and FIG. 4 presents a front-facing view of the filter adapter 100.

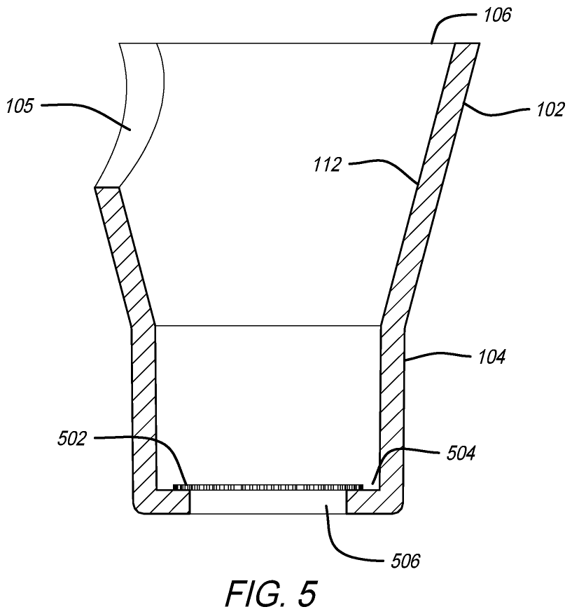

FIG. 5 further depicts a lateral cross-sectional view of the filter adapter 100. As shown, a filter material 502 is situated on a seating 504 within the filter adapter 100. The filter material 502 is removably inserted into the filter adapter 100 from the opening 114. To insert the filter material 502, an operator may press the filter material 502 through the opening 114 and onto the seat 504. This arrangement provide for a relatively simple removal, e.g., for periodic cleaning of the filter material 502.

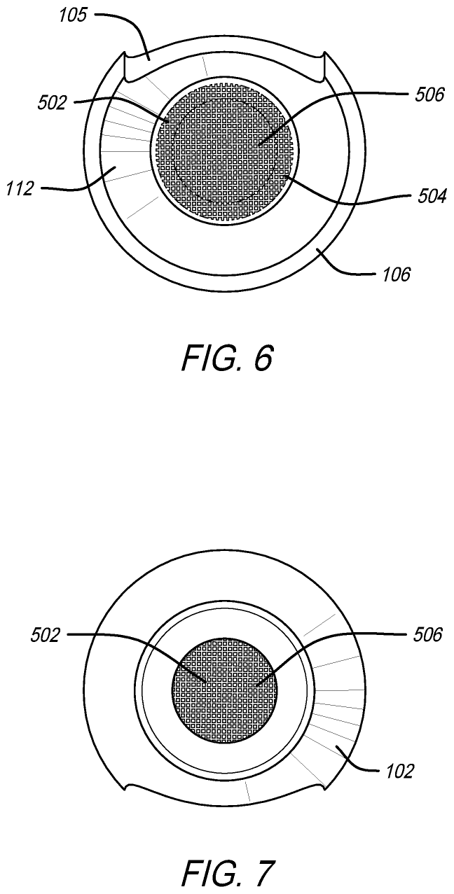

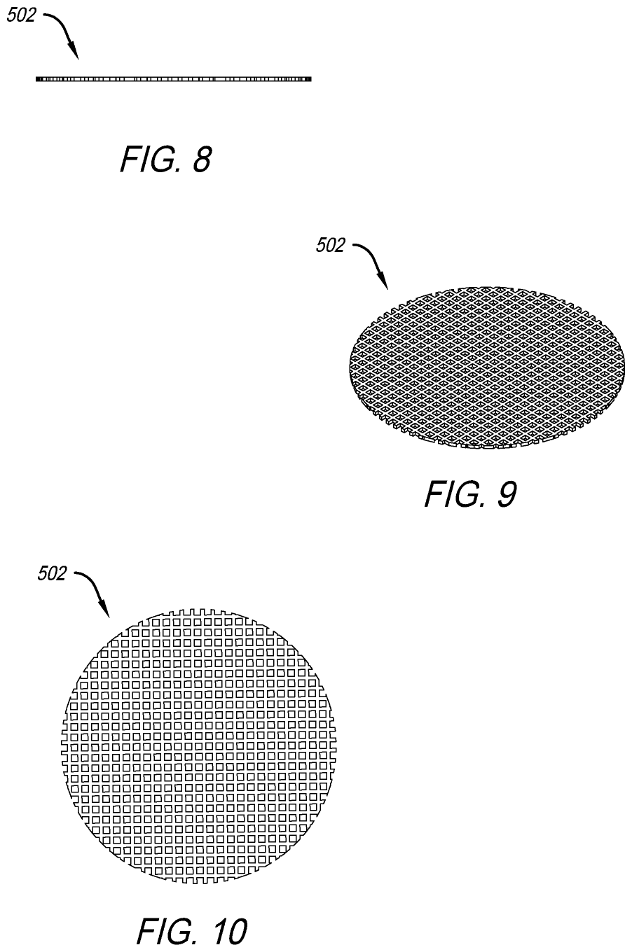

FIGS. 6 and 7 further depict additional views of the filter adapter 100. Specifically, FIG. 6 presents an overhead view of the filter adapter 100, and FIG. 7 presents a view of the filter adapter 100 from the bottom thereof. Illustratively, the filter material 502 is a rectangular-wire circular mesh that fits atop a seat 504 of the filter adapter 100. FIGS. 8-10 provide additional views of the filter material 502, including a side view, a perspective view, and an overhead view, respectively. Illustratively, the filter material 502 is a thin disc. In practice, the filter material 502 is approximately 0.1 inches thick, although other dimensions may be used. Further, as shown in each of FIGS. 8-10, the net open area of each rectangular portion within the mesh is relatively equal to one another. Further, the rectangular portions in the mesh may have dimensions such that elements (e.g., coffee grounds and other similarly sized particles) may be captured without influencing the flow of beverage liquid passing through the filter adapter 100. Further, in an embodiment, the filter material 502 has a diameter that is of a relatively similar dimension to that of the flow diameter of the outlet passage 125 of the server faucet assembly 115. In some cases, the diameter of the filter material 502 may be slightly larger in dimension compared to the flow diameter of the outlet passage 125. In an embodiment, the filter material 502 is formed of a material such as a stainless steel material. The filter material 502 may also have other properties such as antimicrobial characteristics to prevent issues affecting food safety.

In operation, beverage liquid flows through the outlet passage 125 of the server faucet assembly and through the filter adapter 100. The neck 104 of the filter adapter 100 provides an opening for beverage liquid to flow through the filter material 502, thereby flowing out the filter adapter 100 and into a container. By positioning the filter adapter 100 at the outlet passage 125 of the faucet nozzle, any solid remnants flowing from the server reservoir of the beverage brewer are captured at the last possible moment immediately prior to the beverage flowing into a container for consumption. As a result, these solid remnants do not flow into the container with the liquid. In addition, such positioning allows for visibility, creating convenience for the purpose of removing, cleaning, and reinserting the filter adapter 100. Further, by using a filter adapter 100 and material 502 that closely matches the flow diameter provided by the faucet assembly, and by using a filter material 502 sized to adequately capture solid remnants, the flow of the beverage liquid through the filter adapter 100 remains relatively unaffected, so as to not influence properties of the beverage liquid itself.

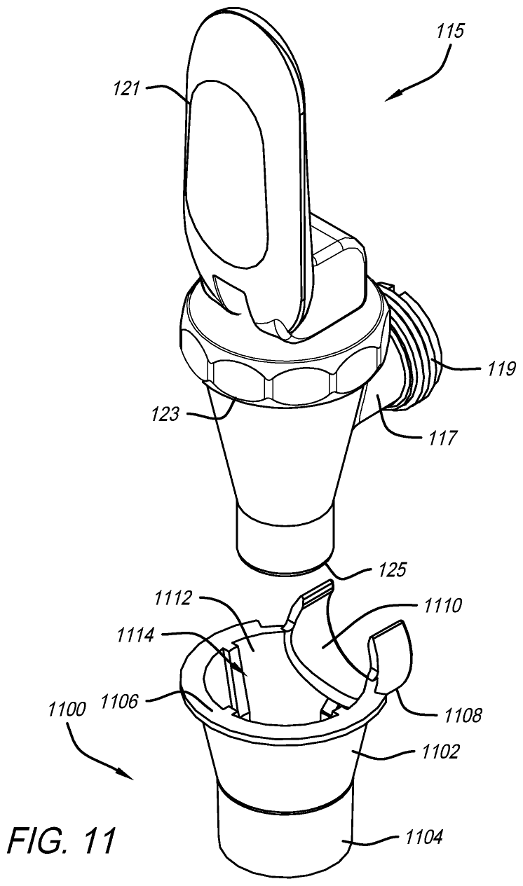

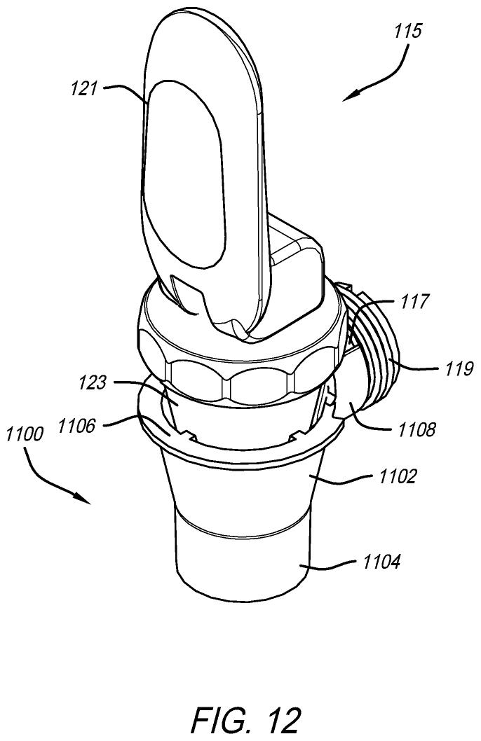

FIG. 11 provides a second embodiment of the filter adapter (here, filter adapter 1100), a filter adapter 1100 removably attachable to the server faucet assembly 115. Similar to the filter adapter 100, the filter adapter 1100 may be removably attached to the server faucet 115, in the manner shown in FIG. 12. As further described herein, the filter adapter 1100 includes a filter material, such as a mesh or a sieve, used to capture such undesirable elements immediately prior to the beverage liquid pouring into the container from the server faucet assembly 115.

In an embodiment, the filter adapter 1100 may be formed of a plastic material, such as polypropylene. Of course, other materials may be used to form the filter adapter 1100, such as stainless steel, silicon, rubber, and so on. In addition, the filter adapter 1100 may incorporate antimicrobial additives to prevent food safety issues such as contamination. Illustratively, the filter adapter 1100 has a generally conically shaped body 1102, a generally cylindrically shaped neck 1104, a lip 1106, a clip attachment 1108 having a clip surface 1110, and an inner body 1112. In an embodiment, the aforementioned components of the filter adapter 1100 may be formed as a single mold. The filtering material, further described herein, may be inserted through an opening 1114 at the upper portion of the body 1102 and within the neck 1104. As shown in FIG. 12, the clip attachment 1108, which generally conforms with the cylindrical shape of the valve chamber 117, may releasably engage with the valve chamber 117 of the server faucet assembly 115. Particularly, the clip attachment 1108 includes ears at the end portions thereof that allow the clip attachment 1108 to attach around the valve chamber 117. Although the illustrative clip attachment 1108 is formed in a half-cylindrical shape, the clip attachment 1108 may be arranged in other configurations, such as an annular shape that is separable at one point to allow the clip attachment 1108 to engage with the valve chamber 117.

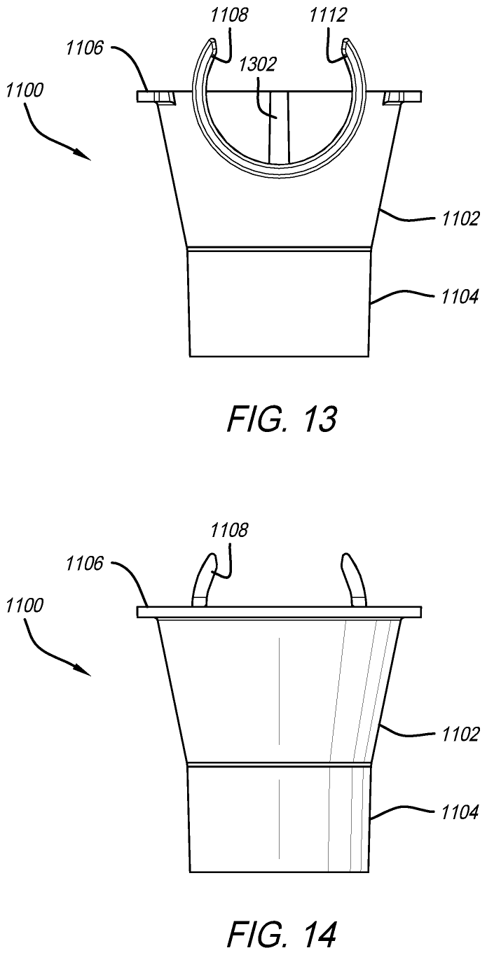

Further, the inner portion of the filter adapter 1100 may be formed in such a manner to be able to seat the faucet assembly 115 therein. In particular, as shown in FIG. 13, the inner portion of the filter adapter 1100 includes one or more raised ribs 1302 protruding therefrom to assist centering of the server faucet 115. FIGS. 13 and 14 depict additional views of the filter adapter 1100. Specifically, FIG. 13 presents a rear-facing view of the filter adapter 1100, and FIG. 14 presents a front-facing view of the filter adapter 1100.

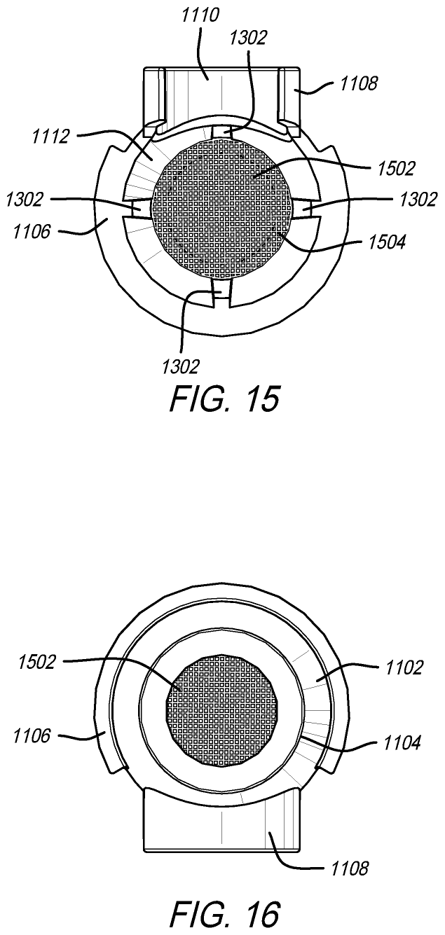

FIGS. 15 and 16 further depict additional views of the filter adapter 1100. Specifically, FIG. 15 presents an overhead view of the filter adapter 1100, and FIG. 16 presents a view of the filter adapter 1100 from the bottom thereof. As shown in FIGS. 15 and 16, a filter material 1502 is removably inserted into the filter adapter 1100 from the opening 1114. Similar to the filter material 502, the filter material 1502 is a rectangular-wire circular mesh. The filter material 1502 fits atop a seat 1504 of the filter adapter 1100. To insert the filter material 1502, an operator may press the filter material 1502 through the opening 1114 and onto the seat 1504.

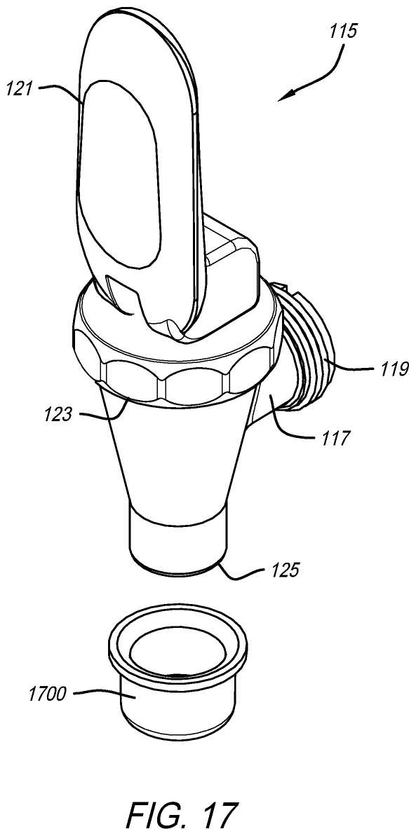

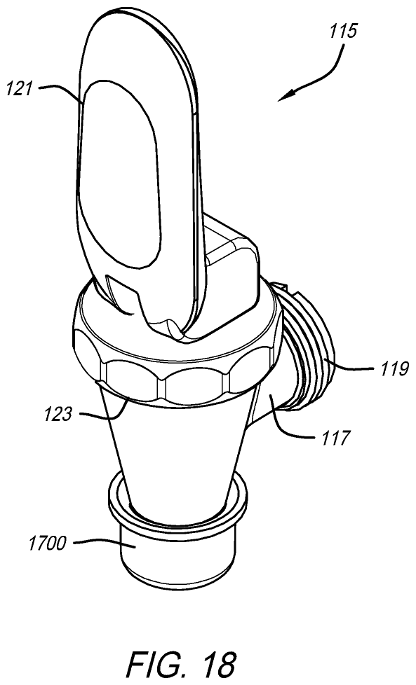

FIG. 17 provides another embodiment of the filter adapter (here, filter adapter 1700). In this example embodiment, the filter adapter 1700 is formed of an elastomeric material, such as silicon rubber, that enables the filter adapter 1700 to slide onto and tightly seal around the nose portion of the faucet body 123, as opposed to snapping onto the shank portion of the faucet body 123. FIG. 18 illustrates the filter adapter 1700 as engaged with the faucet body 123 and aligned with the outlet passage 123. To enable engagement with the faucet body 123, the filter adapter 1700 may be of a shape that is conformable with the nose portion of the faucet body 123. For example, illustratively, the filter adapter 1700 is of a thimble or cup-like shape with a relatively flat base.

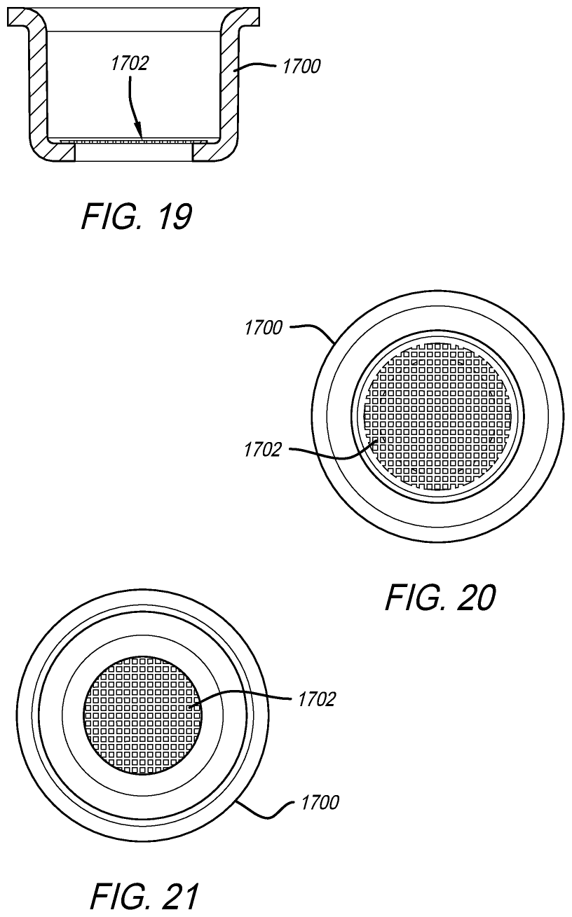

FIGS. 19-21 provide additional views of the filter adapter 1700. Particularly, FIG. 19 provides a lateral cross-section of the filter adapter 1700; FIG. 20 provides an overhead view of the filter adapter 1700; and FIG. 21 provides a view from the bottom of the filter adapter 1700. Illustratively, the filter adapter 1700 includes a filter material 1702, which includes similar properties of the filter material 502 described herein. The diameter of the filter material 1702 is slightly larger than the hole of the bottom portion of the filter adapter 1700, such that the filter material 1702 extends from one end of the inside wall thereof to the other end. Doing so prevents the filter material 1702 from falling through the hole. In an embodiment, the filter material 1702 may be molded into the bottom portion of the filter adapter 1700. In other embodiments, the filter material 1702 may be standalone and manually inserted into the filter adapter 1700 from the top portion thereof.

Advantageously, the material and shape of the filter adapter 1700 allow a relatively tight fit around the nose portion of the faucet body 123, such that the filter material 1702 can capture and filter of undesirable elements (e.g., coffee grounds and other similarly-sized particles) without significantly influencing the flow rate of water as those elements begin to accumulate on the filter material 1702.

1. An apparatus for filtering elements flowing from a beverage server, comprising:
a body comprising an opening;
an outlet passage; and
a filter material seated inside the body through the opening and along the outlet passage, wherein the apparatus is removably attachable to a faucet assembly of the beverage server.

2. The apparatus of claim 1, wherein the body is formed of a elastomeric material conformable with the faucet assembly.

3. The apparatus of claim 2, wherein the body has a generally conical shape with a generally semi-circular-shaped seating conformable with a valve chamber of the faucet assembly.

4. The apparatus of claim 1, further comprising a clip attachment.

5. The apparatus of claim 4, wherein the clip attachment is attachable to a valve chamber of the faucet assembly and the body seats a nozzle of the faucet assembly.

6. The apparatus of claim 4, wherein the clip attachment is formed in a half-cylindrical shape.

7. The apparatus of claim 4, wherein the clip attachment is formed of an annular shape that is separable at a point.

8. The apparatus of claim 4, wherein an interior of the body includes one or more raised ribs protruding therefrom.

9. The apparatus of claim 4, wherein clip attachment includes end portions each having an ear enabling the clip attachment to be attachable to a valve chamber of the faucet assembly.

10. The apparatus of claim 1, wherein the body is of a generally conical shape.

11. The apparatus of claim 1, wherein the body is formed of a plastic material.

12. The apparatus of claim 1, wherein the body is formed of a elastomeric material, and wherein the body is of a generally thimble shape with a flat base.

13. The apparatus of claim 12, wherein the filter material is molded into the body.

14. The apparatus of claim 1, wherein the filter adapter incorporates one or more antimicrobial additives.

15. The apparatus of claim 1, wherein the filter material incorporates one or more antimicrobial additives.

16. The apparatus of claim 1, wherein the filter material is a circular mesh.

17. The apparatus of claim 1, wherein the filter material is formed of a stainless steel material.

18. The apparatus of claim 1, wherein the filter material is a sieve.

19. The apparatus of claim 1, wherein a diameter of the filter material is larger relative to the outlet passage.

20. The apparatus of claim 1, further comprising a neck having a narrower diameter relative to the body, the neck providing a seating for the filter material.
